(19) United States
(12) Patent Application Publication
(10) Pub. No.: US 2006/0234762 A1
(43) Pub. Date: Oct. 19, 2006

(54) Method and apparatus for selecting a communication mode for performing user requested data transfers

(75) Inventor: Fatih Ozluturk, Port Washington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/209,096

(22) Filed: Aug. 22, 2005

Related U.S. Application Data
(60) Provisional application No. 60/667,813, filed on Apr. 1, 2005.

(51) Int. Cl. H04M 1/00

(52) U.S. Cl. 455/552.1

(57) ABSTRACT

A method and apparatus for downloading and uploading digital data using a dual-mode wireless transmit/receive unit (WTRU). When in a first mode, the WTRU communicates with a first network, such as a universal mobile telecommunication system (UMTS). While the WTRU is in the first mode, a user of the WTRU may request the transfer of data to or from the WTRU, (i.e., a download or an upload). The user of the WTRU may also specify whether the data transfer is to occur when the WTRU is in the first mode, or in a second mode when the WTRU is communicating with a second network, such as a wireless local area network (WLAN). The data transfer may occur on a real-time basis or at a later time. In an alternative embodiment, predetermined criteria may be established for implementing automatic WTRU mode selection when data is transferred.

### CROSS REFERENCE TO RELATED APPLICATIONS

This application claims the benefit of U.S. provisional application No. 60/667,813 filed on Apr. 1, 2005, which is incorporated by reference as if fully set forth.

### FIELD OF INVENTION

The present invention is related to a multi-mode wireless transmit/receive unit (WTRU). More particularly, the present invention is related to a method and apparatus for selecting a communication mode of the WTRU for downloading or uploading data, (i.e., information), independent of the current communication mode of the WTRU.

### BACKGROUND

In a conventional wireless communication system 100 including a WTRU 105 and a network 110, as shown in FIG. 1, it is possible for a user 112 of the WTRU 105 to communicate with the network 110 and initiate a data transfer request 115 to upload or download, (i.e., perform a data transfer 120), of data either in real-time or as a batch process when traffic is lower, rates are cheaper, or the like. However, this process does not take into account the capabilities of a multi-mode WTRU for which a data transfer request is only associated with the communication mode that the multi-mode WTRU was in when the request was made. For example, when a user of the multi-mode WTRU makes a request for a download of a music file while operating in a universal mobile telecommunication system (UMTS) mode, the music file would be downloaded over the UMTS air interface, although downloading though another network such as a wireless local area network (WLAN) may be faster and/or cheaper.

FIG. 2 shows a conventional wireless communication system 200 including a dual-mode WTRU 205, a first network 210, (e.g., UMTS), and a second network 215, (e.g., WLAN). As shown in FIG. 2, it is possible for a user 217 of the dual-mode WTRU 205 to communicate with the first network 210 and initiate a data transfer request 220 while the dual-mode WTRU 205 is in a first communication mode to upload or download data, (i.e., perform a data transfer 225), either in real-time or as a batch process, similar to the conventional communication system 100 of FIG. 1. Alternatively, it is possible for the user 217 of the dual-mode WTRU 205 to communicate with the second network 215 and initiate a data transfer request while the dual-mode WTRU 205 is in a second communication mode. Neither of the wireless communication systems 100 and 200 is capable of performing a data transfer 120, 225 while the respective WTRUs 105 and 205 are in a different communication mode than when the request 115, 220 for the data transfer 120, 225 was made BY THE USER 112, 217. Furthermore, the users 112, 217 of the respective WTRUs 105 and 205 are not able to select a communication mode for performing a data transfer that is different than the communication mode that the WTRU 105, 205 is in when the request 115, 220 for the data transfer 120, 225 is made.

### SUMMARY

The present invention is related to a method and apparatus for downloading and uploading digital data using a dual-mode WTRU. When in a first mode, the WTRU communicates with a first network, such as a UMTS. While the WTRU is in the first mode, a user of the WTRU may request the transfer of data to or from the WTRU, (i.e., a download or an upload). The user of the WTRU may also specify whether the data transfer is to occur when the WTRU is in the first mode, or in a second mode when the WTRU is communicating with a second network, such as a WLAN. The data transfer may occur on a real-time basis or at a later time. In an alternative embodiment, predetermined criteria may be established for implementing automatic WTRU mode selection when data is transferred.

### BRIEF DESCRIPTION OF THE DRAWINGS

A more detailed understanding of the invention may be had from the following description of a preferred embodiment, given by way of example and to be understood in conjunction with the accompanying drawing wherein:

FIG. 1 is a block diagram of a conventional wireless communication system including a WTRU used to perform a data transfer;

FIG. 2 is a block diagram of a conventional wireless communication system including a dual-mode WTRU used to perform a data transfer;

FIG. 3 is a block diagram of a wireless communication system including a dual-mode WTRU with manual communication selection which performs a data transfer while the dual-mode WTRU is in a different communication mode than when a request for the data transfer was originally made by a user of the dual-mode WTRU in accordance with the present invention;

FIG. 4 is a block diagram of a wireless communication system including a dual-mode WTRU with an automatic communication mode selection feature which performs a data transfer while the dual-mode WTRU is in a different communication mode than when a request for the data transfer was originally made by a user of the dual-mode WTRU in accordance with the present invention;

FIG. 5 is a flow diagram of a process including method steps for using a dual-mode WTRU to perform a data transfer while in a selected communication mode in accordance with the present invention; and

FIG. 6 is a detailed block diagram of a dual-mode WTRU configured in accordance with the present invention.

### DETAILED DESCRIPTION OF THE PREFERRED EMBODIMENTS

Hereafter, the terminology “WTRU” includes but is not limited to a user equipment (UE), a mobile station, a fixed or mobile subscriber unit, a pager, or any other type of device capable of operating in a wireless environment.

The features of the present invention may be incorporated into an integrated circuit (IC) or be configured in a circuit comprising a multitude of interconnecting components.

The present invention provides an ability to select a mode of communication to be used when a multi-mode WTRU is uploading or downloading (i.e., involved in transferring) data, (i.e., information). Although a dual-mode WTRU will be referred to hereinafter, it should be understood that the WTRU may have more than two modes of communication whereby a request for a data transfer may be made when the WTRU is in any one of those modes. The WTRU includes at least one memory for storing downloaded data and/or data available to be uploaded. The WTRU also includes a transmitter and a receiver which serve as a wireless communication means for supporting data transfers to the Internet via multiple networks.

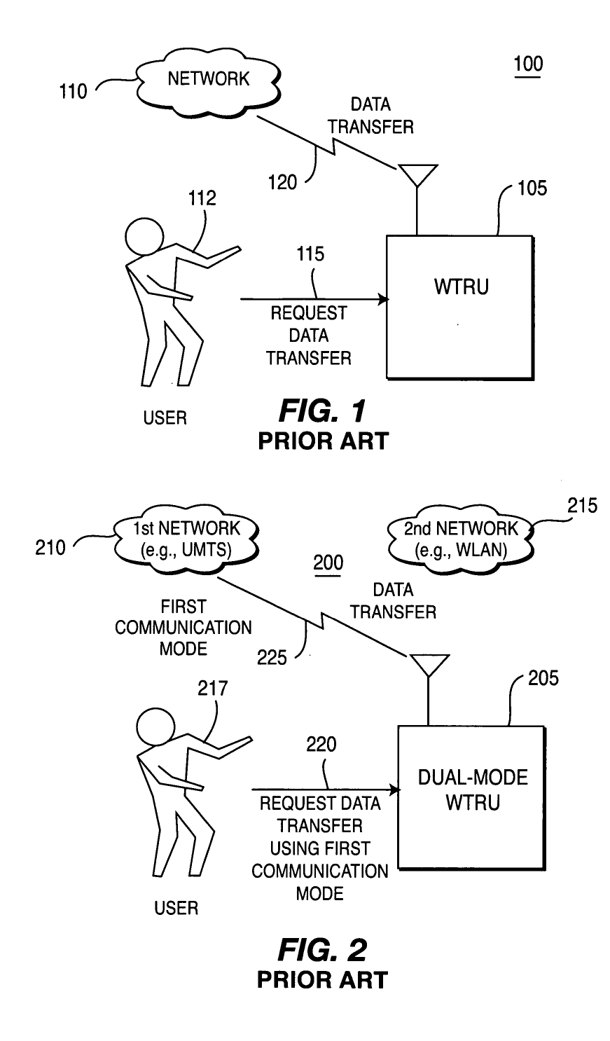

In accordance with the present invention, the communication mode of a dual-mode WTRU used to transfer data is selected independently of the communication mode that the dual-mode WTRU is in when a request for the data transfer is made. The present invention is advantageous over the conventional wireless communication systems 100 and 200 shown in FIGS. 1 and 2 because data is downloaded or uploaded using the most appropriate communication mode.

For example, a user of a UMTS/WLAN dual-mode WTRU may request that a music file, (i.e., content), be downloaded when the WTRU is in either the UMTS mode or the WLAN mode. The file may be downloaded in real-time or as a batch process later depending on user preference. The source of the music file, (and the associated storage), may be a website on the Internet that the WTRU would connect to via either the UMTS or the WLAN. Once the WTRU is connected to the website, the music file is downloaded from a data source having a particular uniform resource locator (URL). Thus, the UMTS and the WLAN serve as transportation paths for downloading the music file from the data source.

In accordance with the present invention, the communication mode used for transferring data may be selected by the user, (i.e., manually), or the communication mode may be automatically selected based on various criteria (including cost, speed, system capacity, availability of reliable links, traffic load, or the like). In the case where the communication mode is automatically selected, the user does not need to manually select which communication mode is to be used to perform the data transfer.

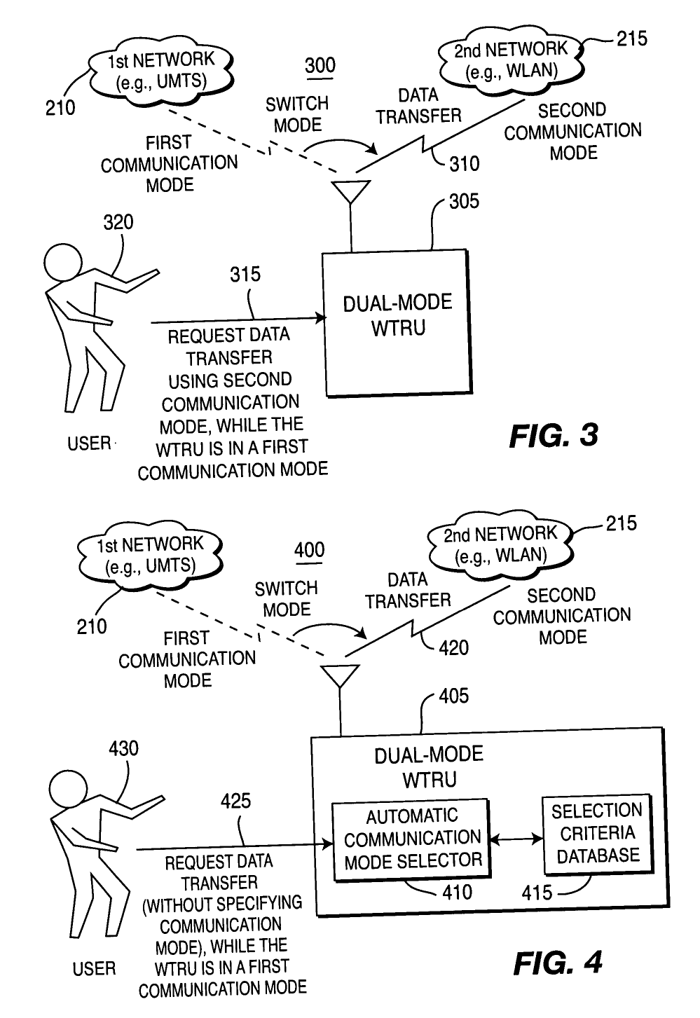

FIG. 3 is a block diagram of a wireless communication system 300 including a dual-mode WTRU 305 with manual communication selection which performs a data transfer 310 while the dual-mode WTRU 305 is in a different communication mode than when a request 315 for the data transfer 310 was originally made by a user 320 of the dual-mode WTRU 305 in accordance with the present invention. The operation of a dual-mode wireless terminal is disclosed in copending U.S. patent application Ser. No. 10/681,025 entitled “System and Method for integrating WLAN and 3G” by Steve Terry, which is incorporated by reference as if fully set forth.

FIG. 4 is a block diagram of a wireless communication system 400 including a dual-mode WTRU 405 with an automatic communication mode selector 410 and a selection criteria database 415. The dual-mode WTRU 405 performs a data transfer 420 while the dual-mode WTRU 405 is in a different communication mode than when a request 425 for the data transfer was originally made by a user 430 of the dual-mode WTRU 405 in accordance with the present invention. Alternatively, at least one of the automatic communication mode selector 410 and the selection criteria database 415 may be located at a remote location outside of the dual-mode WTRU 405, whereby the dual-mode WTRU 405 wirelessly communicates therewith.

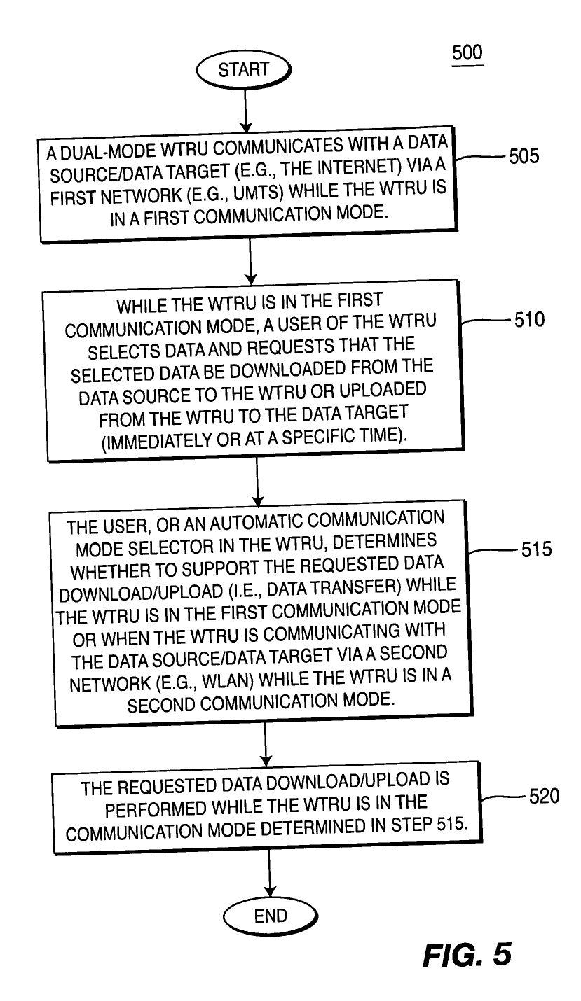

Referring to FIGS. 3-5, FIG. 5 is a flow diagram of a process 500 including method steps for using a dual-mode WTRU 305, 405 to perform a data transfer 310, 420 while in a selected communication mode in accordance with the present invention. In step 505, the dual-mode WTRU 305, 405 communicates with a data source or a data target, (e.g., the Internet), via a first network 210, (e.g., UMTS), while the dual-mode WTRU 305, 405 is in a first communication mode. In step 510, while the dual-mode WTRU 305, 405 is in the first communication mode, a user 320, 430 of the dual-mode WTRU 305, 405 selects data and makes a request 315, 425 that the selected data be downloaded from the data source to the dual-mode WTRU 305, 405 or uploaded from the dual-mode WTRU 305, 405 to the data target, (immediately or at a specific time).

In one embodiment, the request 315 may include additional information specifying which communication mode of the dual-mode WTRU 305 should be used to perform the data transfer 310. In another embodiment, the request 425 does not specify a communication mode. Instead, an automatic communication mode selector 410 in the dual-mode WTRU 405 selects the communication mode to be used for performing the requested data transfer 420 based on criteria stored in a selection criteria database 415.

In step 515, the user 320, 430, or the automatic communication mode selector 410 in the dual-mode WTRU 405, determines whether to support the requested data download/upload, (i.e., data transfer 310, 420), while the dual-mode WTRU 405 is in the first communication mode or when the dual-mode WTRU 405 is communicating with the data source/data target via a second network 215, (e.g., WLAN), while the dual-mode WTRU 405 is in a second communication mode. In step 520, the requested data download/upload is performed while the dual-mode WTRU 405 is in the communication mode determined in step 515.

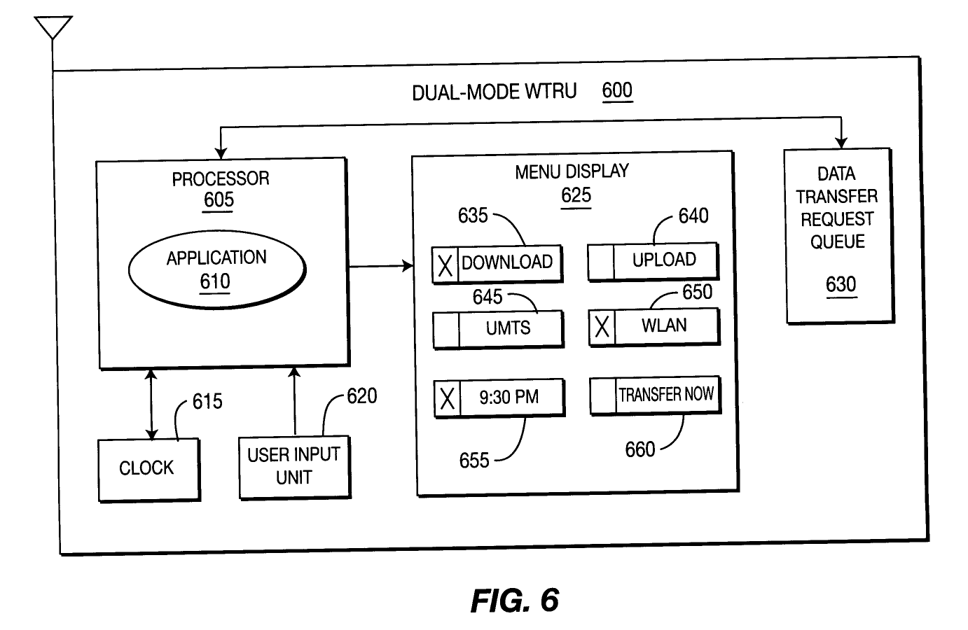

FIG. 6 is a detailed block diagram of a dual-mode WTRU 600 configured in accordance with the present invention. The WTRU 600 includes a processor 605 having an application 610 running thereon, a clock 615, a user input unit 620, a menu display 625 and a data transfer request queue 630. Via the user input unit 620, a user of the WTRU 600 may select the specific data that the user desires to be transferred. The user input unit may be a keypad, keyboard, mouse, touchscreen, voice activation mechanism or any other graphical user interface (GUI).

In a first example, the user of the WTRU 600, (i.e., a PDA), is surfing websites on the Internet and finds a song that the user wants to download to the WTRU 600. The user then enters and/or selects parameters via the user input unit 620 while viewing the menu display 625 to generate a data transfer request to be queued in the data transfer request queue 630 and processed by the processor 605. One parameter presented on the menu display 625 that the user of the WTRU 600 may select is a “download” operation 635, (i.e., a data transfer). Alternatively, an “upload” operation 640 is available but is not applicable to this example. Another parameter that the user of the WTRU 600 may select on the same or a subsequent menu is one of multiple communication modes 645, 650 that the WTRU 600 is capable of using to support the download operation 635. Yet another parameter that the user of the WTRU 600 may select on the same or a subsequent menu is an indication of whether the download operation 635 should be performed immediately 660 or at a later time 655, such as at 9:30 PM in the evening, (as determined by the clock 615), when the user of the WTRU 600 expects to be in the service area that supports the selected communication mode 645, 650.

When the user of the WTRU 600 selects menu option 660 on the menu display 625 for an immediate download while the WTRU 600 is in the UMTS mode, but the user of the WTRU 600 selects the WLAN mode menu option 650 on the menu display 625, the WTRU 600 activates the WLAN mode and completes the downloading process using the WLAN communication mode. The information that specifies what content should be downloaded is indicated by the URL pointing to the desired file. If the menu option 655 to download this content at a later time, (e.g., 9:30 PM), is selected, the WTRU 600 then stores in its data transfer request queue 630 all of the parameters selected by the user including the “address” of the file to be downloaded. This address is typically a URL which point to the content. There are cases where the website at which the content resides is a subscription or membership based service requiring login information, such as a username and/or password. In this case, the login information is also stored in the data transfer request queue 630 of the WTRU 600. The actual mechanism used by the present invention to exchange login information may vary according to various standards.

Once the parameters for the data transfer request are entered on the WTRU 600 and the service associated with the selected communication mode is available, the WTRU 600 proceeds with the download. If the delayed download menu option 655 is selected, or a desired communication mode is not available, (e.g., because the WTRU 600 is out of the service area of the network used to support the desired communication mode), the application 610 running on the processor 605 queues the request in the data transfer request queue and executes the request either when the specified time arrives or when the WTRU 600 determines that it has entered into the service area that supports the selected communication mode of the request. This may require that the contents of the data transfer request queue 630 and the type of service needed to fulfill user requests be checked by the application 610 on a periodic basis.

In another example, once the user requests that a particular song be downloaded, the request may be automatically queued to be executed in a WLAN communication mode 650. Selection of the WLAN communication mode 650 may be made automatically in the setup menus of the application 610 running on the WTRU 600 by indicating, for instance, that all downloads above a certain size, or all downloads associated with a certain file extension, (i.e., type), be performed when the WTRU 610 is in the WLAN communication mode 650.

In another example, a user of the WTRU 600 is listening to music when the WTRU 600 is in the UMTS communication mode 645 and the user wants to download a music file to the WTRU 600 and store the music file in a memory (not shown) so that the user can replay the music as desired. The user makes a request for downloading the music file to the WTRU 600 while the WTRU 600 is the UMTS communication mode 645. Either immediately or later when the user returns home, (or at any other place that a WLAN connection is available), the music file can be downloaded to the WTRU 600 over a WLAN network located in the user's home. When the user indicates by selecting menu options 650 and 660 that the music file should be transferred immediately over a WLAN network, the processor 605 will check the availability of the WLAN service associated with the selected communication mode 645, 650 that the user selected.

Depending on the communication modes involved, air interface standards allow for searching for other communication modes and measurements to detect signal quality. For example, when the communication mode is associated with a time division duplex (TDD) or time division multiple access (TDMA)-based air interface, the WTRU 600 may use the gaps which occur during transmission and/or reception to search for the presence of other communication networks in the area and measure signal quality. In the case of UMTS, there is a mode defined called the “compressed mode” that allows the WTRU 600 to make measurements and search for the presence of global system for mobile communications (GSM) coverage. The actual mechanism that the present invention may use to search for other communication modes may vary according to various standards. If a desired service is not available, (i.e., the WTRU 600 is not in a hotspot WLAN area when menu option 650 is selected), the WTRU 600 may let the user know via the menu display 625 or via any other type of alert, (i.e., audible, visible or the like), that the selected communication mode 650 is not available and the user may be presented with several alternative options.

When the user selects a task, such as downloading a file at a requested time, the WTRU 600 will perform the download as previously described. Alternatively, the WTRU 600 will perform queued communication tasks when the WTRU 600 is placed on its cradle, is connected to a computer, or the like. Thus, the WTRU 600 may use a wired connection, which may be cheaper and more reliable, to accomplish the queued communication tasks instead of relying on more expensive and/or unreliable wireless communication services.

Uploading is performed by the present invention in a similar fashion to downloading, except that content is transferred in the other direction. In the case of uploading content to a website, (e.g., a picture file), the user of the WTRU 600 selects the desired options from the menu display 625 and indicates whether the upload is to take place immediately by selecting option 660, or later on by selecting option 655, and selecting either menu option 645 or 650 to designate which communication mode should be used to support the upload. If the upload is to be performed immediately, the WTRU 600 searches for the presence of the desired network associated with the selected communication mode and, once service is found, the upload is performed. During the upload, the WTRU 600 transfers content from a memory therein to a website selected by the user of the WTRU 600. In the case that the upload is to take place at a later specified time, parameters selected by the user including the URL of where the content is to be uploaded and any login information, if appropriate, is queued in the data transfer request queue 630. At the specified time, the WTRU 600 uploads the content to the website in accordance with the corresponding information queued in the data transfer request queue 630.

The present invention offers the user of a WTRU the option to choose the cheapest or most preferred communication mode to use for performing data transfers, based on the user's needs. Since the WTRU is aware of what communication modes it is capable of, and what communication services are available at any time to support data transfer operations, (i.e., uploads and downloads), performed by the WTRU, the WTRU can determine on a periodic basis when the user's criteria is satisfied and the data transfer should take place.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A method of transferring data using a wireless transmit/receive unit (WTRU), the WTRU having at least two communication modes available for supporting the transfer of data, the method comprising:
(a) the WTRU establishing a connection with a first wireless communication network while the WTRU is operating in a first one of the communication modes;
(b) a user of the WTRU selecting data to be transferred while the WTRU is in the first communication mode;
(c) the user of the WTRU indicating that a second one of the communication modes is to be used to support the transfer of the selected data; and
(d) transferring the selected data while the WTRU is connected to a second wireless communication network associated with the second communication mode.

2. The method of claim 1 wherein data is transferred from the WTRU to the second wireless communication network.

3. The method of claim 1 wherein data is transferred from the second wireless communication network to the WTRU.

4. The method of claim 1 wherein the first wireless communication network is a universal mobile telecommunication system (UMTS).

5. The method of claim 4 wherein the second wireless communication network is and a wireless local area network (WLAN).

6. The method of claim 1 wherein the transferred data is used by the WTRU to play a song.

7. The method of claim 1 further comprising:
(e) the user of the WTRU indicating a destination for data to be transferred to or from a memory located in the WTRU.

8. The method of claim 1 further comprising:
(e) the user of the WTRU indicating an address of a data source from which data is to be transferred to the WTRU.

9. The method of claim 1 further comprising:
(e) the user of the WTRU indicating a time when the data transfer is to take place.

10. The method of claim 1 further comprising:
(e) the user of the WTRU indicating that the data transfer is to take place immediately.

11. A method of transferring data using a wireless transmit/receive unit (WTRU), the WTRU having at least two communication modes available for supporting the transfer of data, the method comprising:
(a) the WTRU establishing a connection with a first wireless communication network while the WTRU is operating in a first one of the communication modes;
(b) a user of the WTRU selecting data to be transferred while the WTRU is in the first communication mode;
(c) the WTRU automatically determining that a second one of the communication modes is to be used to support the transfer of the selected data; and
(d) transferring the selected data while the WTRU is connected to a second wireless communication network associated with the second communication mode.

12. The method of claim 11 wherein step (c) comprises checking the availability status of at least one of the first and second wireless communication networks on a periodic basis.

13. The method of claim 11 wherein step (c) comprises determining the amount of data to be transferred.

14. The method of claim 11 wherein step (c) comprises determining a file type associated with the data to be transferred.

15. The method of claim 11 wherein data is transferred from the WTRU to the second wireless communication network.

16. The method of claim 11 wherein data is transferred from the second wireless communication network to the WTRU.

17. The method of claim 11 wherein the first wireless communication network is a universal mobile telecommunication system (UMTS).

18. The method of claim 17 wherein the second wireless communication network is and a wireless local area network (WLAN).

19. The method of claim 11 wherein the transferred data is used by the WTRU to play a song.

20. The method of claim 11 further comprising:
(e) the user of the WTRU indicating a destination for data to be transferred to or from a memory located in the WTRU.

21. The method of claim 11 further comprising:
(e) the user of the WTRU indicating an address of a data source from which data is to be transferred to the WTRU.

22. The method of claim 11 further comprising:
(e) the user of the WTRU indicating a time when the data transfer is to take place.

23. The method of claim 11 further comprising:
(e) the user of the WTRU indicating that the data transfer is to take place immediately.

24. A wireless transmit/receive unit (WTRU) having at least two communication modes available for supporting the transfer of data, the WTRU comprising:
(a) a wireless communication means capable of establishing a connection with a first wireless communication network while the WTRU is operating in a first one of the communication modes;
(b) a menu display capable of presenting menu options to a user of the WTRU; and
(c) a user input unit capable of allowing the user to select data to be transferred and generate a transfer request for the selected data while the WTRU is in the first communication mode, and capable of allowing the user to select a second wireless communication network to support the transfer of the selected data while the WTRU is in a second one of the communication modes.

25. The WTRU of claim 24 wherein data is transferred from the WTRU to the second wireless communication network.

26. The WTRU of claim 24 wherein data is transferred from the second wireless communication network to the WTRU.

27. The WTRU of claim 24 wherein the first wireless communication network is a universal mobile telecommunication system (UMTS).

28. The WTRU of claim 27 wherein the second wireless communication network is and a wireless local area network (WLAN).

29. The WTRU of claim 24 wherein the transferred data is used by the WTRU to play a song.

30. The WTRU of claim 24 wherein a user of the WTRU uses the user input unit to indicate a destination for data to be transferred to or from a memory located in the WTRU.

31. The WTRU of claim 24 wherein a user of the WTRU uses the user input unit to indicate a destination for data to be transferred to or from a memory located in the WTRU.

32. The WTRU of claim 24 wherein a user of the WTRU uses the user input unit to indicate an address of a data source from which data is to be transferred to the WTRU.

33. The WTRU of claim 24 wherein a user of the WTRU uses the user input unit to indicate a time when the data transfer is to take place.

34. The WTRU of claim 24 wherein a user of the WTRU uses the user input unit to indicate that the data transfer is to take place immediately.

35. A wireless transmit/receive unit (WTRU) having at least two communication modes available for supporting the transfer of data, the WTRU comprising:
(a) a wireless communication means capable of establishing a connection with a first wireless communication network while the WTRU is operating in a first one of the communication modes;
(b) a menu display capable of presenting menu options to a user of the WTRU;
(c) a user input unit capable of allowing the user to select data to be transferred and generate a transfer request for the selected data while the WTRU is in the first communication mode; and
(d) an automatic communication mode selector for automatically determining that a second wireless communication network is to be used to support the transfer of the selected data while the WTRU is in a second one of the communication modes.

36. The WTRU of claim 35 wherein data is transferred from the WTRU to the second wireless communication network.

37. The WTRU of claim 35 wherein data is transferred from the second wireless communication network to the WTRU.

38. The WTRU of claim 35 wherein the first wireless communication network is a universal mobile telecommunication system (UMTS).

39. The WTRU of claim 38 wherein the second wireless communication network is and a wireless local area network (WLAN).

40. The WTRU of claim 35 wherein the transferred data is used by the WTRU to play a song.

41. The WTRU of claim 35 wherein a user of the WTRU uses the user input unit to indicate a destination for data to be transferred to or from a memory located in the WTRU.

42. The WTRU of claim 35 wherein a user of the WTRU uses the user input unit to indicate a destination for data to be transferred to or from a memory located in the WTRU.

43. The WTRU of claim 35 wherein a user of the WTRU uses the user input unit to indicate an address of a data source from which data is to be transferred to the WTRU.

44. The WTRU of claim 35 wherein a user of the WTRU uses the user input unit to indicate a time when the data transfer is to take place.

45. The WTRU of claim 35 wherein a user of the WTRU uses the user input unit to indicate that the data transfer is to take place immediately.

46. The WTRU of claim 35 wherein the results of the determination performed by the automatic communication mode selector is based on the availability status of at least one of the first and second wireless communication networks.

47. The WTRU of claim 35 wherein the results of the determination performed by the automatic communication mode selector is based on the amount of data to be transferred.

48. The WTRU of claim 35 wherein the determination performed by the automatic communication mode selector is based on a file type associated with the data to be transferred.
